(19) United States
(12) Patent Application Publication
(10) Pub. No.: US 2026/0185628 A1
(43) Pub. Date: Jul. 2, 2026

(54) ELECTRIC HYDRAULIC THERMAL CONTROL VALVE

(71) Applicant: Ingersoll-Rand Industrial U.S., Inc., Davidson, NC (US)

(72) Inventors: Taylor Stratman, Quincy, IL (US); Lukas Gray, Loraine, IL (US); Evan Schreacke, Quincy, IL (US)

(21) Appl. No.: 19/410,258

(22) Filed: Dec. 5, 2025

Related U.S. Application Data
(60) Provisional application No. 63/741,254, filed on Jan. 2, 2025.

(51) Int. Cl. F16K 31/06; F01P 7/14; F16K 11/07

(52) U.S. Cl. CPC F16K 31/0613; F01P 7/14; F16K 11/0716; F01P 2007/146

(57) ABSTRACT

An electric hydraulic thermal control valve (EHTCV) is configured to control the temperature of a coolant fluid to a compressor airend. The EHTCV includes a valve housing portion defining a chamber, a solenoid valve coupled to the valve housing portion, and a movable sleeve disposed within the chamber and configured to move between an idle position, at least one intermediate position, and an actuated position. A controller energizes the solenoid valve to direct a portion of the coolant fluid to the valve housing portion to move the sleeve towards the actuated position and direct cold coolant fluid to the compressor airend. In the idle position, the movable sleeve bypasses a cooler and directs hot coolant fluid to the compressor airend. In the at least one intermediate position, the movable sleeve directs hot coolant fluid and cold coolant fluid into the compressor airend.

### BACKGROUND

Compressors increase the pressure of a compressible fluid (e.g., air, gas, etc.) by reducing the volume of the fluid. Often, compressors, particularly contact-cooled compressors and oil-free compressors, are staged so that the fluid is compressed several times in different stages, to further increase the discharge pressure of the fluid. As the pressure of the fluid increases, the temperature of the fluid also increases. In some compressors, the compressed fluid may be cooled between stages with a cooling system.

### DRAWINGS

The Detailed Description is described with reference to the accompanying figures. The use of the same reference numbers in different instances in the description and the figures may indicate similar or identical items.

FIG. 1 is an isometric view of a compressor assembly having a coolant circulation system with an electric hydraulic thermal control valve (EHTCV) in accordance with example embodiments of the present disclosure.

FIG. 2 is a top cross-sectional view of a compressor airend including the EHTCV shown in FIG. 1 cut along line 2-2, in accordance with example embodiments of the present disclosure.

FIG. 3 is an isometric cross-sectional view of the EHTCV shown in FIG. 1 cut along line 3-3, having a movable sleeve in an idle position, in accordance with example embodiments of the present disclosure.

FIG. 4 is an isometric cross-sectional view of the EHTCV shown in FIG. 1 cut along line 4-4, having a movable sleeve in an intermediate position, in accordance with example embodiments of the present disclosure.

FIG. 5 is an isometric cross-sectional side view of the EHTCV shown in FIG. 1 cut along line 5-5, having a movable sleeve in an actuated position, in accordance with example embodiments of the present disclosure.

FIG. 6 is an isometric cross-sectional side view of an EHTCV having a first end diameter that is greater than a second end diameter, in accordance with example embodiments of the present disclosure.

FIG. 7 is a schematic view of a fluid compressor system having a coolant circulation system including an EHTCV system with a two-way solenoid valve, in accordance with example embodiments of the present disclosure.

FIG. 8 is a schematic view of a fluid compressor system having a coolant circulation system including an EHTCV system with a three-way solenoid valve, in accordance with example embodiments of the present disclosure.

### DETAILED DESCRIPTION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

### Overview

Contact-cooled fluid compressors include a coolant circulation system that circulates a coolant fluid (e.g., oil, water, etc.) that is injected into compression cavities within a compressor airend to aid cooling of the working fluid to be compressed. The coolant fluid may also provide lubrication and sealing of the compressor airend. A discharge stream of pressurized working fluid and coolant mixture is discharged from the contact-cooled airend at a high temperature and separated in a separator tank. After separation in the separator tank, the coolant fluid is directed to a temperature control valve system (TCV). Depending on the desired airend discharge temperature, the TCV system may direct the coolant fluid back to circulation in the contact-cooled airend or may direct the coolant fluid to a cooler for cooling prior to recirculation. Some TCVs regulate the airend discharge temperature by regulating the amount of coolant fluid that flows into the cooler. Other TCVs regulate the airend discharge temperature by regulating the amount of cooled coolant fluid that flows from the cooler into the compressor airend. The coolant fluid temperature is controlled to prevent condensation, for example, in a screw compressor package.

Typical TCVs use wax elements (e.g., wax thermostats) and/or electronic elements (e.g., stepper motors) to drive the operation of the TCVs. These elements are often unreliable and require constant maintenance, particularly replacement of dynamic seals, which are prone to leakage and other types of failure. Moreover, the wax thermostats keep coolant fluid temperatures at a constant high temperature, regardless of ambient conditions. Additionally, present TCVs are often large in dimension, as they must accommodate the various mechanical and electronic elements.

Accordingly, the present disclosure is directed to an electric hydraulic thermal control valve (EHTCV) system that dynamically regulates the temperature of coolant fluid entering into the compressor airend to maintain a desired airend discharge temperature in a fluid compressor system. The EHTCV system includes a solenoid valve that directs a portion of coolant fluid from the separation tank to apply pressure on a first end of a valve housing portion to actuate a movable sleeve from an idle position to an actuated position. In the idle position, the movable sleeve allows coolant fluid that has bypassed the cooler into the compressor airend. In the actuated position, the movable sleeve allows coolant fluid that has circulated through the cooler into the compressor airend. An EHTCV controller, in communication with a plurality of temperature and humidity sensors, controls the actuation of the solenoid valve to dynamically control the temperature of the coolant fluid flowing through the airend, resulting in a desired discharge temperature while avoiding condensation.

### Detailed Description of Example Embodiments

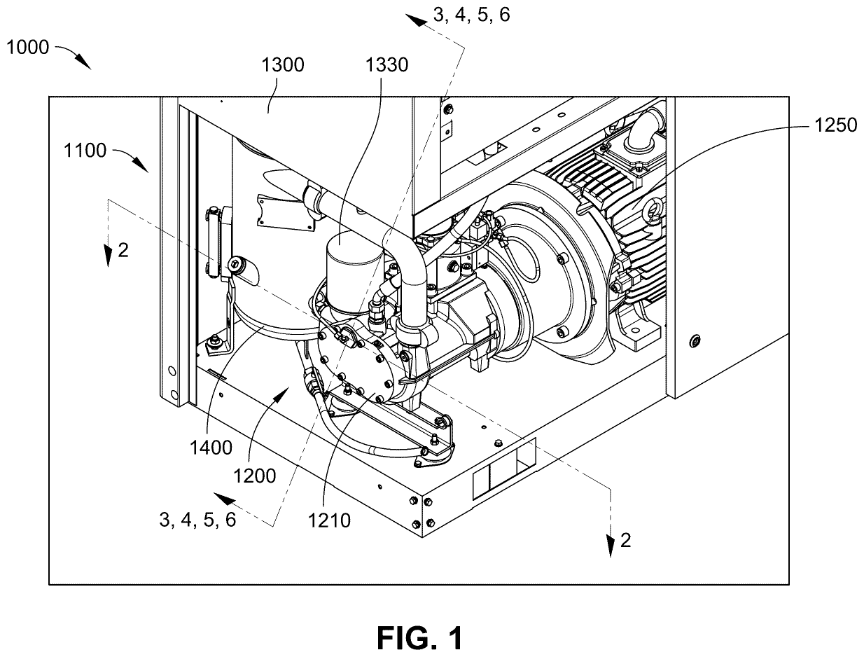

Referring generally to FIGS. 1 through 8, a fluid compressor system 1000 is shown. The fluid compressor system 1000 includes a coolant circulation system 1100, at least one compressor airend 1200, a cooler 1300, and a separation tank 1400. The compressor airend 1200 compresses the working fluid (e.g., air, gas, etc.) of the fluid compressor system 1000 in at least a first compression stage. This compression stage increases the temperature of the working fluid. During the compression, the working fluid is mixed with a coolant fluid (e.g., oil, water, synthetic coolants, etc.) to reduce the temperature of the discharged working fluid and prevent water condensation in the discharged working fluid. The fluid discharged from the compressor airend 1200 is thus a working fluid and coolant fluid mixture. This discharge fluid is directed to the separation tank 1400 to separate the mixture back into the working fluid and the coolant fluid. The cooler 1300 cools the coolant fluid that will flow through the compressor airend 1200, lowering the temperature of the working fluid prior to flowing to a next stage of the compression process.

The coolant circulation system 1100 includes an electric hydraulic thermal control valve (EHTCV) system 100, hereinafter called the EHTCV 100. The EHTCV 100 acts as a temperature management system of the coolant circulation system 1100, controlling the temperature of a coolant fluid needed to send to the compressor airend 1200 in order to maintain a desired airend discharge temperature of the compressor airend 1200 and/or the desired discharge temperature of the fluid compressor system 1000. In embodiments, the next stage of the compression process may be at least a second compression stage (not shown). However, the coolant circulation system 1100 may further provide cooling to more than two compression stages or a single-stage fluid compressor system as shown.

In the example embodiments described, the fluid compressor system 1000 includes a contact-cooled rotary (CCR) compressor, and the coolant used in the coolant circulation system 1100 is oil. In other embodiments, the coolant may be water, or another fluid configured to remove excess heat from the working fluid, keeping the airend discharge temperature within a desired temperature range.

The EHTCV 100 includes a valve housing portion 102, a solenoid valve 110 coupled to the valve housing portion 102, and a movable sleeve 120 disposed within the valve housing portion 102. The valve housing portion 102 is defined (e.g., formed) within an airend casing 1210 of the compressor airend 1200. The valve housing portion 102 comprises a chamber 104 and a coolant fluid outlet 106. The chamber 104 houses the movable sleeve 120. The coolant fluid outlet 106 is connected to a compression chamber 1220 of the compressor airend 1200. In other embodiments, the valve housing portion 102 is coupled to a side of the casing 1210. In some embodiments, the coolant fluid 106 outlet is directly connected to the compression chamber 1220. In other embodiments (not shown), the valve housing may be separate from the airend housing, wherein the valve housing and the airend housing may be in fluid communication with one another.

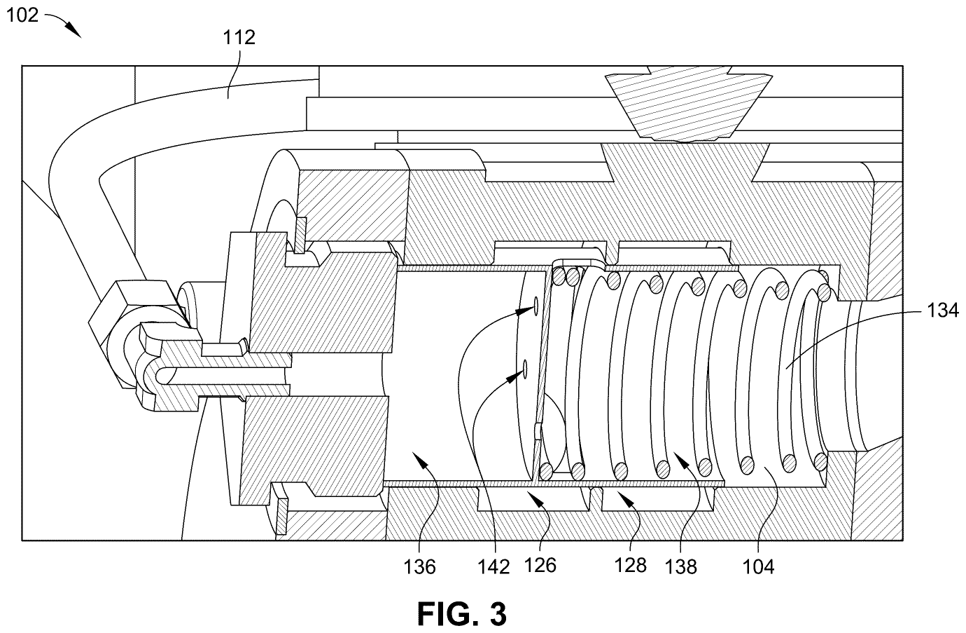

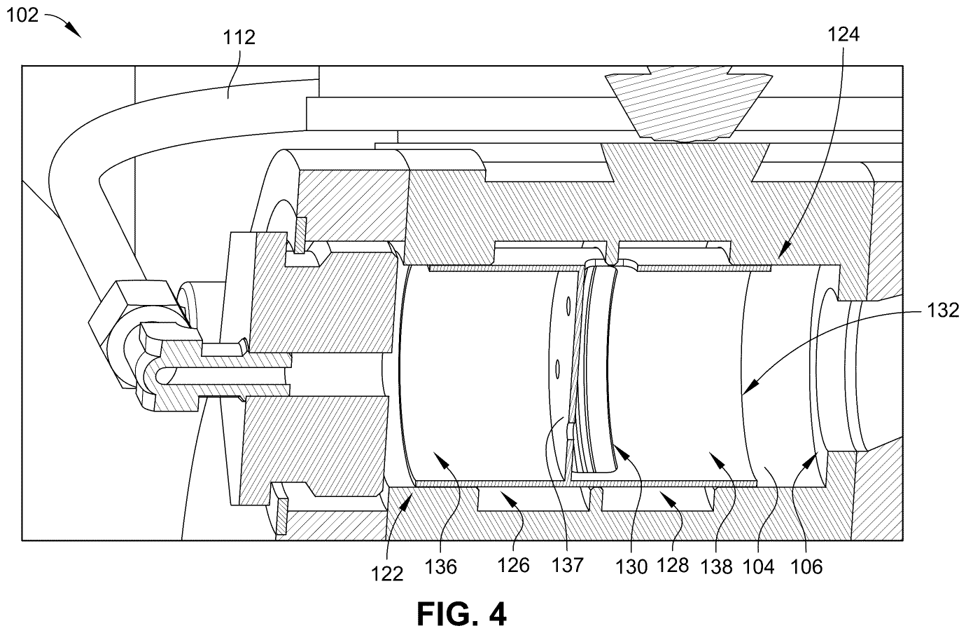

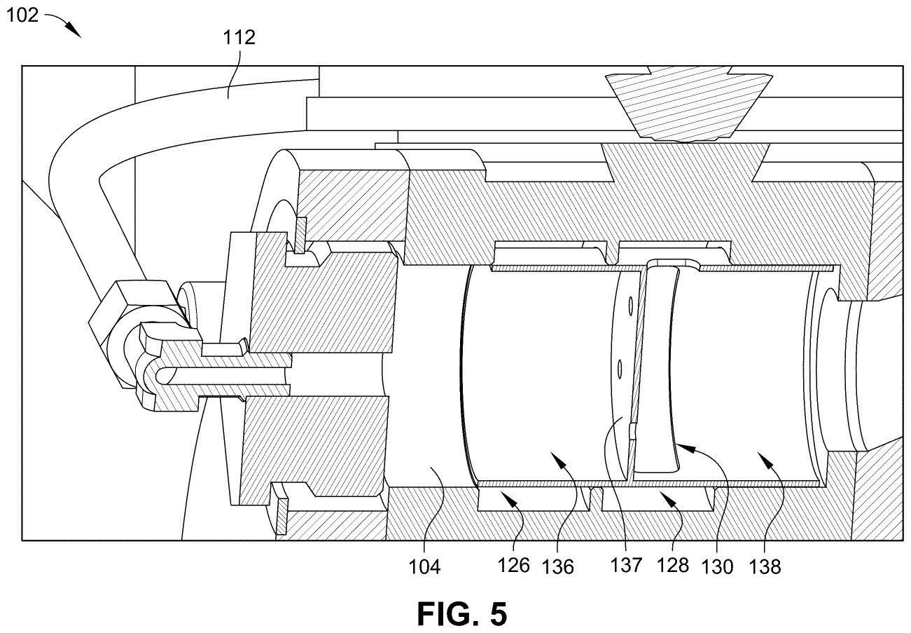

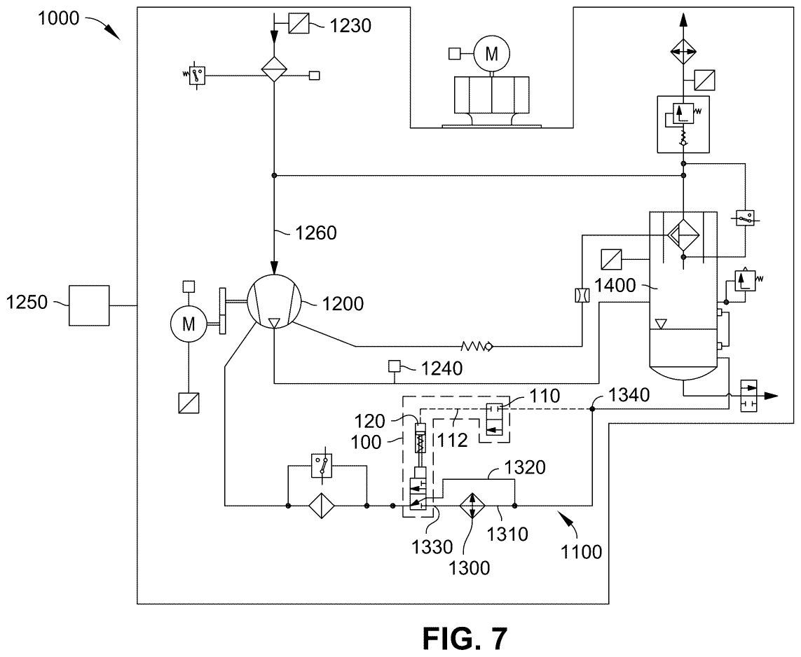

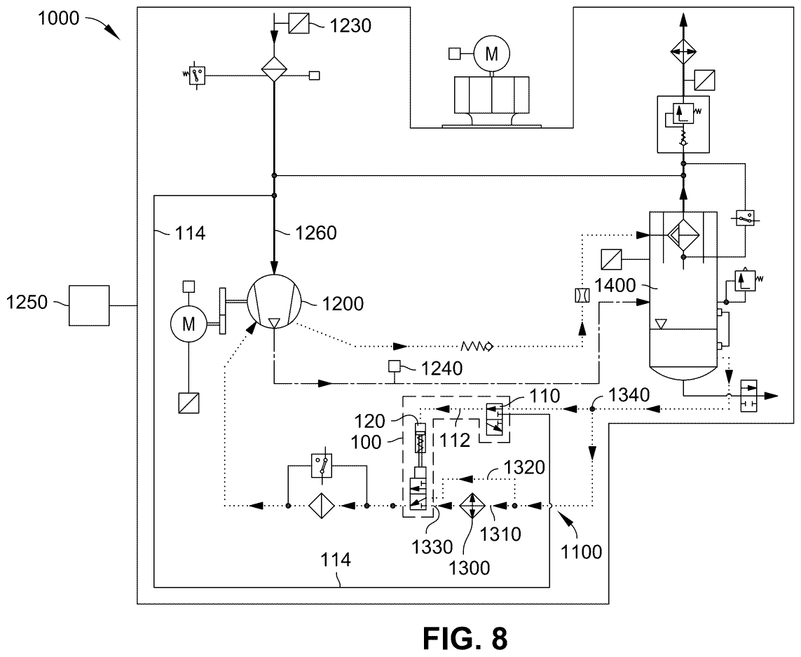

The solenoid valve 110 is disposed between the separation tank 1400 and the valve housing portion 102. When energized, the solenoid valve 110 is configured to direct a portion of the coolant fluid from the separation tank 1400, through a solenoid line 112, to the valve housing portion 102. The portion of the coolant fluid actuates the movable sleeve 120 by creating a pressure difference or pressure buildup that moves the movable sleeve 120 from an idle position (see FIG. 3), through an intermediate position (see FIG. 4), to an actuated position (see FIG. 5). In example embodiments, described further below, the solenoid valve 110 may be either a two-way solenoid valve or a three-way solenoid valve. A two-way solenoid valve configuration is shown in the diagram illustrated in FIG. 7. A three-way solenoid valve configuration is shown in the diagram illustrated in FIG. 8. In other embodiments, the fluid compressor system 1000 having multiple compression stages may include both a two-way solenoid valve coupled to a first compression stage and a three-way solenoid valve coupled to a second compression stage.

The solenoid valve 110 is controlled by an EHTCV controller 1250 in communication with at least one sensor. Based on real-time, on-site conditions, the EHTCV controller 1250 is configured to energize the solenoid valve 110 of the EHTCV 100. For example, the EHTCV controller 1250 may receive an input temperature, or a desired airend temperature to maintain. In embodiments, the EHTCV controller 1250 receives information from an inlet humidity sensor 1230 and a discharge temperature sensor 1240. In other embodiments, the EHTCV controller 1250 may be in communication with more than one temperature sensor and/or more than one humidity sensor and/or other types of sensors, such as but not limited to airend temperature sensors, pressure sensors, working fluid humidity sensors, ambient temperature sensors, ambient humidity sensors, etc.

In embodiments, at least one temperature input of the airend discharge is provided to the EHTCV controller 1250 to control the solenoid valve 110 to position the movable sleeve 120 at a desired position from among the plurality of intermediate positions to achieve a desired airend coolant injection temperature. In addition to the airend discharge temperature input, an additional ambient humidity and ambient temperature input may be sent to the valve control system to allow for the calculation of a pressure-dew-point temperature for the working fluid and the coolant fluid mixture. The EHTCV controller 1250 may receive input from at least one of the inlet humidity sensor 1230, the discharge temperature sensor 1240, or another sensor, and control the position of the movable sleeve 120 of the solenoid valve 110 based on the sensor readings. This data may enable the valve control system to maintain the coldest airend discharge temperature possible without forming condensation in the coolant fluid.

As shown, the coolant circulation system 1100 includes a coolant manifold 1340 to direct the coolant fluid delivered by the separation tank 1400. The coolant manifold 1340 may be coupled to at least the EHTCV 100, a cooler line 1310, and a bypass line 1320. During operation, after being separated from the working fluid in the separation tank 1400, the coolant fluid may be directed to the cooler 1300 through the cooler line 1310 or bypass the cooler 1300 through the bypass line 1320. The cooled coolant fluid may exit the cooler 1300 through a cooler line 1330.

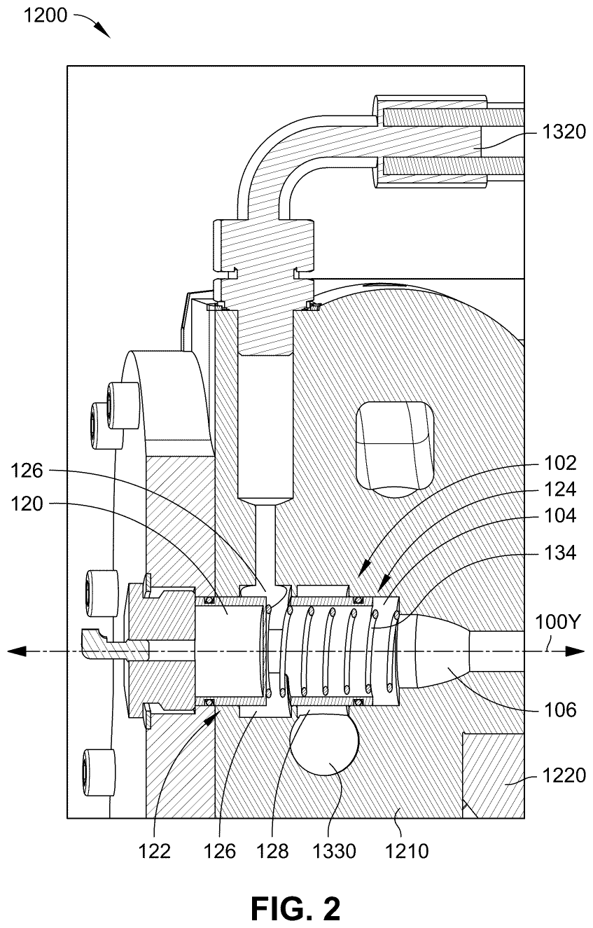

As shown in FIGS. 2 through 6, the valve housing portion 102 includes a hot coolant fluid groove 126 and a cold coolant fluid groove 128 defined around the chamber 104. The cold coolant fluid groove 128 is configured to receive the coolant fluid flow from the cooler 1300 through the cooler line 1330. The hot coolant fluid groove 126 is configured to receive the coolant fluid that bypasses the cooler 1300 through the bypass line 1320.

As shown in FIG. 4, the movable sleeve 120 is disposed within the chamber 104 and includes a coolant fluid sleeve inlet 130, a coolant fluid sleeve outlet 132, a first end 122, and a second end 124 along a longitudinal axis 100Y, the second end 124 opposite the first end 122. The movable sleeve 120 defines a first end chamber 136 proximate to the first end 122 and a second end chamber 138 proximate to the second end 124. A dividing wall 137 divides the first end chamber 136 from the second end chamber 138. The coolant fluid sleeve inlet 130 is disposed on a surface of the movable sleeve 120 and fluidly connects the chamber 104 with the second end chamber 138.

As shown in FIGS. 3 through 5, the movable sleeve 120 is configured to be moved between a plurality of positions along the longitudinal axis 100Y. As the solenoid valve 110 is energized by the EHTCV controller 1250, it directs coolant fluid from the separator tank 1400 to the first end chamber 136. As the coolant fluid fills the first end chamber 136, it causes a pressure buildup on the first end 122 of the movable sleeve 120 and pushes the movable sleeve 120 along the longitudinal axis 100Y in the direction of the second end 124. In other embodiments (not shown) the solenoid valve 110 may be connected upstream of the separator tank 1400, where the solenoid valve directs a working fluid and coolant mixture to the first end chamber 136 and creating the pressure buildup.

For example, the movable sleeve is configured to move between an idle position (FIG. 3), an intermediate position (FIG. 4), and an actuated position (FIG. 5). Depending on a position of the movable sleeve, the coolant fluid sleeve inlet 130 may be located adjacent (fluidly coupled) to the hot coolant fluid groove 126, allowing a coolant fluid flow that has bypassed the cooler 1300, or adjacent (fluidly coupled) to the cold coolant fluid groove 128, allowing a coolant fluid flow that has passed through the cooler 1300, into the second end chamber 138. The coolant fluid sleeve outlet 132 is axially aligned to the coolant fluid outlet 106 along axis 100Y and is configured to fluidly connect the second end chamber 138 with the coolant fluid outlet 106.

Based on the sensor readings sent to the EHTCV controller 1250, the solenoid valve 110 may be energized or de-energized to move the movable sleeve 120 depending on the desired temperature of the coolant fluid entering the compression chamber 1220. If the temperature of the coolant fluid mixing with the working fluid in the compression chamber 1220 is to be decreased, the solenoid valve 110 is energized to create a pressure buildup in the first end chamber 136. The movable sleeve 120 is moved to the actuated position, allowing coolant fluid delivered by the cooler 1300 to flow through the second end chamber 138 and into the compression chamber 1220. In contrast, if the temperature of the discharged fluid is to be increased, the solenoid valve remains de-energized, allowing the first end chamber 136 of the movable sleeve to vent the built-up pressure, and allowing the movable sleeve 120 to move back to the idle position. In this idle position, the movable sleeve allows the coolant fluid bypassing the cooler 1300 to flow through the second end chamber 138 and into the compression chamber 1220.

The movable sleeve 120 moves from the actuated position through the plurality of intermediate positions and into the idle position when the built-up pressure in the first end chamber 136 is vented. In example embodiments where the solenoid valve 110 is a two-way solenoid valve, as shown in FIG. 7, the dividing wall 137 includes at least one venting orifice 142. The at least one venting orifice 142 is configured to vent the fluid from the first end chamber 136 into the second end chamber 138 to reduce the pressure of the fluid in the first end chamber 136 when the solenoid valve 110 is de-energized. By venting the built-up pressure, the movable sleeve 120 is able to move from the actuated position toward the idle position. This movement may be further facilitated by a biasing component 134, as discussed below.

In example embodiments, as shown in FIGS. 2 and 3, the movable sleeve 120 is biased in a direction towards the first end 122 by the biasing component (e.g., a spring) 134. The biasing component 134 may mechanically and/or magnetically bias the movable sleeve 120 towards a desired position. For example, the biasing component 134 may be a compression spring, a tension spring, or the like. In the embodiment shown, the biasing component 134 is configured to return the movable sleeve 120 to the idle position when the solenoid valve 110 is no longer energized by the EHTCV controller 1250, directing the coolant fluid flow that has bypassed the cooler 1300 into the compression chamber 1220. If the coolant circulation system 1100 or the fluid compressor system 1000 is shut down, the movable sleeve 120 would remain biased towards the idle position.

In other embodiments (not shown), the biasing component 134 may bias the movable sleeve 120 towards the second end 124. In other embodiments (not shown) the EHTCV 100 may include a plurality of biasing components 134 or may not include any biasing component 134 biasing the movable sleeve 120 towards any predetermined position.

In example embodiments where the solenoid valve 110 is a three-way solenoid valve, as shown in FIG. 8, the solenoid valve 110 is configured to supply a pressure build-up to the first-end chamber 136 of the movable sleeve 120, and vent the pressure built-up in the first-end chamber 136 of the movable sleeve 120. The solenoid valve 110 is connected to an intake line 1260 of the compressor airend 1200 via a vent line 114. The solenoid valve 110 is configured to vent the fluid from the first end chamber 136 to reduce the pressure of the fluid in the first end chamber 136. By venting the built-up pressure, the movable sleeve 120 is able to move from the actuated position toward the idle position and allow hot coolant fluid flow, or the coolant fluid flow that bypassed the cooler 1300, to flow into the compression chamber 1220 of the compressor airend 1200.

In example embodiments, the solenoid valve 110 is a proportional solenoid valve, where the valve's position moves proportionally to the current applied to it by the EHTCV control. The more current is supplied to the solenoid valve 110, the higher the pressure build-up of coolant fluid within the first-end chamber 136 is. This relationship between the current supplied to the solenoid valve 110 and the pressure build-up in the first end chamber 136 allows to vary the movement of the movable sleeve to a plurality of intermediate positions by controlling the amount of the current supplied to the solenoid valve 110, which in turn controls the temperature of coolant fluid flowing to the compression chamber 1220.

If the temperature of the working fluid and/or the airend discharge temperature exceeds a predetermined range, the valve EHTCV controller 1250 fully energizes the solenoid valve 110, actuating the movable sleeve 120 to the actuated position, where the coolant fluid sleeve inlet 130 is completely open to the cold coolant fluid groove 128. This directs the entirety of the cold coolant fluid flow from the cooler line 1330 to the compression chamber 1220 through the second end chamber 138 of the movable sleeve 120. If the desired temperature of the working fluid and/or the airend discharge temperature reaches a desired temperature, the EHTCV controller 1250 may vent the EHTCV 100 and move the movable sleeve to one of the plurality of intermediate positions, where the coolant fluid sleeve inlet 130 is partially open to the cold coolant fluid groove 128 and the hot coolant fluid groove 126. If the temperature of the working fluid and/or the airend discharge temperature drops below a predetermined range, the valve EHTCV controller 1250 fully de-energizes the solenoid valve 110, moving the movable sleeve 120 to the idle position, where the coolant fluid sleeve inlet 130 is completely open to the hot coolant fluid groove 126. This directs the entirety of the bypassed coolant fluid flow from the bypass line 1320 to the compression chamber 1220 through the second end chamber 138 of the movable sleeve 120.

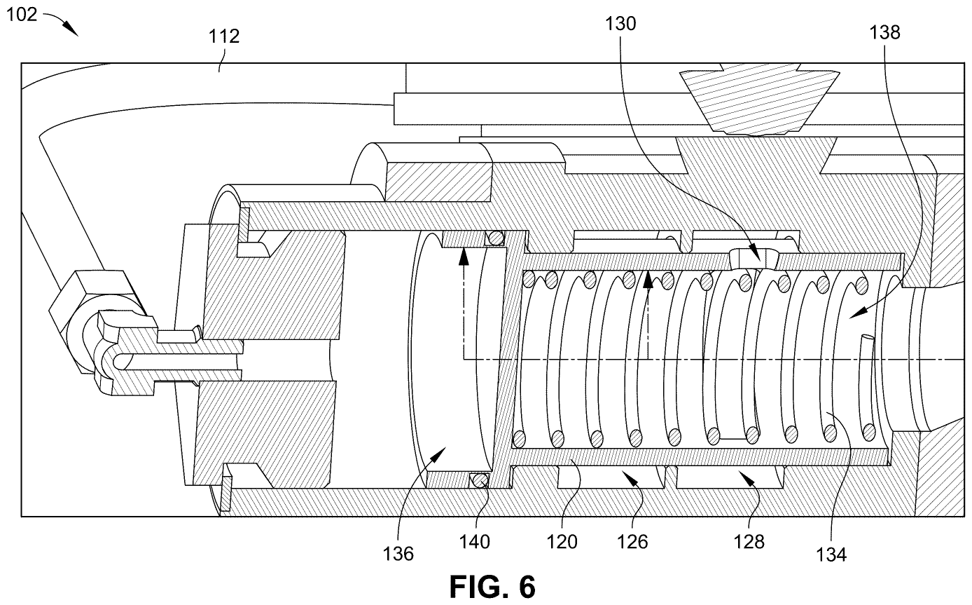

Referring to FIG. 6, the movable sleeve 120 may have a first end chamber 136 having a diameter greater than the diameter of the second end chamber 138. In these embodiments, the surface area of the retaining wall 137 on the first end chamber 136 is greater than the surface area of the retaining wall on the second end chamber 138. This change in the volume and area of the first end chamber increases the force available for moving the movable sleeve 120 with a low differential pressure. This embodiment may be used with a two-way solenoid valve 110 and/or with a three-way solenoid valve 110.

In the example embodiment shown in FIG. 6, the seal 140 is an O-ring seal. The seal 140 is configured to provide sealing and temperature control to the movable sleeve 120. In other example embodiments, the seal may be a U-ring, a V-ring, a flat seal, a lip seal, guide rings, among others. The ring seals may be composed of Polytetrafluoroethylene (PTFE), nitrile, neoprene, ethylene propylene diene monomer (EPDM) rubber, a fluorocarbon rubber, or a combination thereof. This embodiment may be used with a two-way solenoid valve 110 and/or with a three-way solenoid valve 110.

Additionally, the EHTCV controller 1250 may be in communication with a controller that controls a variable speed cooling fan on air cooled compressor packages, for improved energy efficiency of a fan motor energy consumption (i.e.: slow it down as appropriate). The valve control system may also use the data acquired by one or more of the sensors discussed above to send to the controller for the operation of other compressor components such as, but not limited to, drain valves and integrated dryers, or external system components such as standalone dryers and drain valves.

In another embodiment (not shown), the EHTCV 100 may be connected differently to the components of the coolant circulation system 1100, including but not limited to the separator tank 1400, the cooler 1300, such as an evaporator or a heat exchanger, the compressor airend 1200, another temperature controlled valve (TCV), another EHTCV, etc. For example, in the CCR compressor, after being separated from the working fluid and discharged from the separator tank 1400, the EHTCV 100 may control the amount of coolant fluid that is delivered to the cooler 1300. The EHTCV 100 may be disposed between the separator tank 1400 and the cooler 1300, where the EHTCV 100 can control and selectably direct the coolant flow in the coolant circulation system 1100 towards the cooler (e.g., the evaporator) or the airend 1200 based on the desired temperature of the coolant flow.

In another embodiment (not shown), the coolant circulation system 1100 may include a first cooler, a second cooler, a primary EHTCV and a secondary EHTCV fluidly connected to a respective contact-cooled airend. In this embodiment, the coolant fluid may be directed to a secondary EHTCV after exiting a first cooler, where the secondary EHTCV selectably directs the cooled coolant to a second cooler for further cooling or back into the contact-cooled airend through the primary EHTCV, depending on the desired temperature of the coolant prior to entering the contact-cooled airend. In example embodiments, the fluid compressor system 1000 may have any number of EHTCVs and is not limited to having only a primary and a secondary EHTCV in connection with a respective airend. In embodiments, the cooler 1300 may be a brazed plate heat exchanger, but any other type of heat exchanger may be used to absorb heat from the hot coolant according to example embodiments of the present disclosure.

In example embodiments, the fluid compressor system 1000 includes a CCR screw compressor. In other example embodiments (not shown), the fluid compressor system 1000 may have an oil-free rotary (OFR) screw compressor, a rotary vane compressor, a reciprocating compressor, a centrifugal compressor, or an axial compressor. In other example embodiments, the EHTCV may be incorporated or retrofitted with other equipment having a compression application, including but not limited to, heating, ventilation, and air conditioning (HVAC) systems, refrigeration systems, gas turbine systems, automotive applications, and so forth. In yet another example, the EHTCV may be used as a three-way valve and used in operations with power tools, pumps, blowers, medical devices, etc.

While the subject matter has been illustrated and described in detail in the drawings and foregoing description, the same is to be considered as illustrative and not restrictive in character, it being understood that only some embodiments have been shown and described and that all changes and modifications that come within the spirit of the subject matter are desired to be protected. In reading the claims, it is intended that when words such as “a,” “an,” “at least one,” or “at least one portion” are used there is no intention to limit the claim to only one item unless specifically stated to the contrary in the claim. Unless specified or limited otherwise, the terms “mounted,” “connected,” and “coupled” and variations thereof are used broadly and can encompass both direct and indirect mountings, connections, supports, and couplings. Further, “connected” and “coupled” are not necessarily restricted to physical or mechanical connections or couplings.

What is claimed is:

1. A coolant circulation system for regulating a discharge temperature in a compressor airend, the coolant circulation system comprising:
a separator tank configured to separate a mixed fluid into a working fluid and a coolant fluid;
a cooler configured to cool the coolant fluid for circulation through the compressor airend; and
an electric hydraulic thermal control valve (EHTCV) system configured to control the temperature of the coolant fluid circulated to the compressor airend, the EHTCV system including:
a valve housing portion defining a chamber,
a solenoid valve coupled to the valve housing portion, and
a movable sleeve disposed within the chamber and configured to move between an idle position, at least one intermediate position, and an actuated position, the movable sleeve having a first end chamber coupled to the solenoid valve,
wherein when the solenoid valve is energized, the solenoid valve directs a portion of the coolant fluid from the separator tank to the valve housing portion to move the movable sleeve towards the actuated position.

2. The coolant circulation system of claim 1, wherein the valve housing portion further defines a cold coolant fluid groove, a hot coolant fluid groove, and a coolant fluid outlet.

3. The coolant circulation system of claim 2, wherein the movable sleeve includes a second end chamber opposite the first end chamber, a coolant fluid sleeve inlet and a coolant fluid sleeve outlet, the coolant fluid sleeve inlet and the coolant fluid sleeve outlet in fluid communication with the second end chamber, and the coolant fluid sleeve outlet aligned with the coolant fluid outlet of the valve housing portion.

4. The coolant circulation system of claim 3, wherein at the idle position, the coolant fluid sleeve inlet and the hot coolant fluid groove are aligned, allowing hot coolant fluid into the second end chamber and through the coolant fluid outlet, bypassing the cooler.

5. The coolant circulation system of claim 3, wherein at the actuated position, the coolant fluid sleeve inlet and the cold coolant fluid groove are aligned, allowing cold coolant fluid into the second end chamber and through the coolant fluid outlet.

6. The coolant circulation system of claim 3, wherein at the at least one intermediate position, the coolant fluid sleeve inlet rests between the hot coolant fluid groove and the cold coolant fluid groove, allowing both hot coolant fluid and cold coolant fluid into the second end chamber and through the coolant fluid outlet.

7. The coolant circulation system of claim 3, wherein a dividing wall is disposed between the first end chamber and the second end chamber, wherein the dividing wall defines at least one venting orifice configured to vent the fluid from the first end chamber into the second end chamber to reduce the pressure of the fluid in the first end chamber when the solenoid valve is de-energized, causing the movable sleeve to move from the actuated position toward the idle position.

8. The coolant circulation system of claim 3, wherein a diameter of the first end chamber is larger than the diameter of the second end chamber.

9. The coolant circulation system of claim 1, wherein the solenoid valve is in fluid communication with a working fluid inlet of the compressor airend, the solenoid valve configured to vent the fluid from the first end chamber to the working fluid inlet to reduce the pressure of the fluid in the first end chamber when the solenoid valve is de-energized and cause the movable sleeve to move from the actuated position toward the idle position.

10. The coolant circulation system of claim 1, wherein the EHTCV system further includes a biasing component configured to bias the movable sleeve to the idle position, when the solenoid valve is not energized.

11. The coolant circulation system of claim 10, wherein the biasing component is at least one of a compression spring or a tension spring.

12. An electric hydraulic thermal control valve (EHTCV) system configured to control the temperature of a coolant fluid circulated to a compressor airend, the EHTCV system comprising:
a valve housing portion defining a chamber,
a solenoid valve coupled to the valve housing portion, and
a movable sleeve disposed within the chamber and configured to move between an idle position, at least one intermediate position, and an actuated position, the movable sleeve having a first end chamber coupled to the solenoid valve,
wherein when the solenoid valve is energized, the solenoid valve directs a portion of a coolant mixed fluid prior to being separated to the valve housing portion to move the movable sleeve towards the actuated position, the mixed fluid being a mix of coolant and working fluid compressed by the compressor airend.

13. The EHTCV system of claim 12, wherein the valve housing portion further defines a cold coolant fluid groove, a hot coolant fluid groove, and a coolant fluid outlet.

14. The EHTCV system of claim 13, wherein the movable sleeve includes a second end chamber opposite the first end chamber, a coolant fluid sleeve inlet and a coolant fluid sleeve outlet, the coolant fluid sleeve inlet and the coolant fluid sleeve outlet in fluid communication with the second end chamber, and the coolant fluid sleeve outlet aligned with the coolant fluid outlet of the valve housing portion.

15. The EHTCV system of claim 14, wherein at the idle position, the coolant fluid sleeve inlet and the hot coolant fluid groove are aligned, allowing hot coolant fluid into the second end chamber and through the coolant fluid outlet, by-passing a cooler, and wherein at the actuated position, the coolant fluid sleeve inlet and the cold coolant fluid groove are aligned, allowing cold coolant fluid into the second end chamber and through the coolant fluid outlet.

16. The EHTCV system of claim 14, wherein a dividing wall is disposed between the first end chamber and the second end chamber, wherein the dividing wall defines at least one venting orifice configured to vent the fluid from the first end chamber into the second end chamber to reduce the pressure of the fluid in the first end chamber when the solenoid valve is de-energized, causing the movable sleeve to move from the actuated position toward the idle position.

17. The EHTCV system of claim 14, wherein a diameter of the first end chamber is larger than the diameter of the second end chamber.

18. The EHTCV system of claim 12, wherein the solenoid valve is in fluid communication with a working fluid inlet of the compressor airend, the solenoid valve configured to vent the fluid from the first end chamber to the working fluid inlet to reduce the pressure of the fluid in the first end chamber when the solenoid valve is de-energized and cause the movable sleeve to move from the actuated position toward the idle position.

19. An electric hydraulic thermal control valve (EHTCV) system configured to control the temperature of a coolant fluid circulated to a compressor airend, the EHTCV system comprising:
a valve housing portion defining a chamber,
a solenoid valve coupled to the valve housing portion, and
a movable sleeve disposed within the chamber and configured to move between an idle position, at least one intermediate position, and an actuated position, the movable sleeve having a first end chamber coupled to the solenoid valve,
wherein when the solenoid valve is energized, the solenoid valve directs a portion of the coolant fluid from a separator tank to the valve housing portion to move the movable sleeve towards the actuated position.

20. The EHTCV system of claim 19, wherein the valve housing portion further defines a cold coolant fluid groove, a hot coolant fluid groove, and a coolant fluid outlet, wherein the movable sleeve includes a second end chamber opposite the first end chamber, a coolant fluid sleeve inlet and a coolant fluid sleeve outlet, the coolant fluid sleeve inlet and the coolant fluid sleeve outlet in fluid communication with the second end chamber, and the coolant fluid sleeve outlet aligned with the coolant fluid outlet of the valve housing portion,
wherein at the idle position, the coolant fluid sleeve inlet and the hot coolant fluid groove are aligned, allowing hot coolant fluid into the second end chamber and through the coolant fluid outlet, bypassing a cooler.
